(19) United States
(12) Patent Application Publication
(10) Pub. No.: US 2005/0015471 A1
(43) Pub. Date: Jan. 20, 2005

(54) Secure cluster configuration data set transfer protocol

(76) Inventors: Pu Paul Zhang, San Jose, CA (US); Duc Pham, Cupertino, CA (US); Tien Le Nguyen, Cupertino, CA (US); Peter Tsai, Pleasanton, CA (US)

Correspondence Address: GERALD B ROSENBERG;NEW TECH LAW, 285 HAMILTON AVE, SUITE 520, PALO ALTO, CA, 94301, US

(21) Appl. No.: 10/622,596

(22) Filed: Jul. 18, 2003

(51) Int. Cl. G06F 15/177

(52) U.S. Cl. 709/221; 713/201

(57) ABSTRACT

Communications between server computer systems of a cluster routinely exchange notice of configuration status and, on demand, transmit updated configuration data sets. Each status message identifies any change in the local configuration of a servers and, further, includes encrypted validation data. Each of the servers stores respective configuration data including respective sets of data identifying the servers known to the respective servers as participating in the cluster. Each status message, as received, is validating against the respective configuration data stored by the receiving server. A status message is determined valid only when originating from a server as known by the receiving server, as determined from the configuration data held by the receiving server. Where a validated originating server identifies updated configuration data, the receiving server requests a copy of the updated configuration data set, which must also be validated, to equivalently modify the locally held configuration data. The configuration of the cluster thus converges on the updated configuration.

### BACKGROUND OF THE INVENTION

1. Field of the Invention

The present invention is generally related to the coordinated control of server systems utilized to provide network services and, in particular, to techniques for securely coordinating and distributing configuration data among a cluster of network servers and coordinating the implementation of the configuration data with respect to the cluster systems and host computers systems that request execution of network services.

2. Description of the Related Art

The concept and need for load-balancing arises in a number of different computing circumstances, most often as a requirement for increasing the reliability and scalability of information serving systems. Particularly in the area of networked computing, load-balancing is commonly encountered as a means for efficiently utilizing, in parallel, a large number of information server systems to respond to various processing requests including requests for data from typically remote client computer systems. A logically parallel arrangement of servers adds an intrinsic redundant capability while permitting performance to be scaled linearly, at least theoretically, through the addition of further servers. Efficient distribution of requests and moreover the resulting load then becomes an essential requirement to fully utilizing the paralleled cluster of servers and maximizing performance.

Many different systems have been proposed and variously implemented to perform load-balancing with distinctions typically dependent on the particularities of the load-balancing application. Chung et al. (U.S. Pat. No. 6,470,389) describes the use of a server-side central dispatcher that arbitrates the selection of servers to respond to client domain name service (DNS) requests. Clients direct requests to a defined static DNS cluster-server address that corresponds to the central dispatcher. Each request is then redirected by the dispatcher to an available server that can then return the requested information directly to the client. Since each of the DNS requests are atomic and require well-defined server operations, actual load is presumed to be a function of the rate of requests made to each server. The dispatcher therefore implements just a basic hashing function to distribute requests uniformly to the servers participating in the DNS cluster.

The use of a centralized dispatcher for load-balancing control is architecturally problematic. Since all requests flow through the dispatcher, there is an immediate exposure to a single-point failure stopping the entire operation of the server cluster. Further, there is no direct way to scale the performance of the dispatcher. To handle larger request loads or more complex load-balancing algorithms, the dispatcher must be replaced with higher performance hardware at substantially higher cost.

As an alternative, Chung et al. proposes broadcasting all client requests to all servers within the DNS cluster, thereby obviating the need for a centralized dispatcher. The servers implement mutually exclusive hash functions in individualized broadcast request filter routines to select requests for unique local response. This approach has the unfortunate consequence of requiring each server to initially process, to some degree, each DNS request, reducing the effective level of server performance. Further, the selection of requests to service based on a hash of the requesting client address in effect locks individual DNS servers to statically defined groups of clients. The assumption of equal load distribution will therefore be statistically valid, if at all, only over large numbers of requests. The static nature of the policy filter routines also means that all of the routines must be changed every time a server is added or removed from the cluster to ensure that all requests will be selected by a unique server. Given that in a large server cluster, individual server failures are not uncommon and indeed must be planned for, administrative maintenance of such a cluster is likely difficult if not impractical.

Other techniques have been advanced to load-balance networks of servers under various operating conditions. Perhaps the most prevalent load-balancing techniques take the approach of implementing a background or out-of-channel load monitor that accumulates the information necessary to determine when and where to shift resources among the servers dynamically in response to the actual requests being received. For example, Jorden et al. (U.S. Pat. No. 6,438,652) describes a cluster of network proxy cache servers where each server further operates as a second level proxy cache for all of the other servers within the cluster. A background load monitor observes the server cluster for repeated second level cache requests for particular content objects. Excessive requests for the same content satisfied from the some second level cache is considered an indication that the responding server is overburdened. Based on a balancing of the direct or first level cache request frequency being served by a server and the second level cache request frequency, the load monitor determines whether to copy the content object to one or more other caches, thereby spreading the second level cache work-load for broadly and repeatedly requested content objects.

Where resources, such as simple content objects, cannot be readily shifted to effect load-balancing, alternate approaches have been developed that characteristically operate by selectively transferring requests, typically represented as tasks or processes, to other servers within a cluster network of servers. Since a centralized load-balancing controller is preferably to be avoided, each server is required to implement a monitoring and communications mechanism to determine which other server can accommodate a request and then actually provide for the corresponding request transfer. The process transfer aspect of the mechanism is often implementation specific in that the mechanism will be highly dependent on the particular nature of the task to transfer and range in complexity from a transfer of a discrete data packet representing the specification of a task to the collection and transport of the entire state of an actively executing process. Conversely, the related conventional load monitoring mechanisms can be generally categorized as source or target oriented. Source oriented servers actively monitor the load status of target servers by actively inquiring of and retrieving the load status of at least some subset of target servers within the cluster. Target oriented load monitoring operates on a publication principle where individual target servers broadcast load status information reflecting, at a minimum, a capacity to receive a task transfer.

In general, the source and target sharing of load status information is performed at intervals to allow other servers within the cluster to obtain on demand or aggregate over time some dynamic representation of the available load capacity of the server cluster. For large server clusters, however, the load determination operations are often restricted to local or server relative network neighborhoods to minimize the number of discrete communications operations imposed on the server cluster as a whole. The trade-off is that more distant server load values must propagate through the network over time and, consequently, result in inaccurate loading reports that lead to uneven distribution of load.

A related problem is described in Allon et al. (U.S. Pat. No. 5,539,883). Server load values, collected into a server cluster load vector, are incrementally requested or advertized by the various servers of the server cluster. Before a server transfers a local copy of the vector, the load values for the server are updated in the vector. Servers receiving the updated vector in turn update the server local copy of the vector with the received load values based on defined rules. Consequently, the redistribution of load values for some given neighborhood may expose an initially lightly loaded server to a protracted high demand for services. The resulting task overload and consequential refusal of service will last at least until a new load vector reflecting the higher server load values circulates among a sufficient number of the servers to properly reflect the load. To alleviate this problem, Allon et al. further describes a tree-structured distribution pattern for load value information as part of the load-balancing mechanism. Based on the tree-structured transfer of load information, low load values, identifying lightly loaded servers, are aged through distribution to preclude lightly loaded servers from being flooded with task transfers.

Whether source or target originated, load-balancing based on the periodic sharing of load information between the servers of the server cluster operates on the fundamental assumption that the load information is reliable as finally delivered. Task transfer rejections are conventionally treated as fundamental failures and, while often recoverable, require extensive exception processing. Consequently, the performance of individual servers may tend to degrade significantly under progressively increasing load, rather than stabilize, as increasing numbers of task transfer recovery and retries operations are required to ultimately achieve a balanced load distribution.

In circumstances where high load conditions are normally incurred, specialized network protocols have been developed to accelerate the exchange and certainty of loading information. Routers and other switch devices are often clustered in various configurations to share network traffic load. A linking network protocol is provided to provide fail-over monitoring in local redundant router configurations and to share load information between both local and remote routers. Current load information, among other shared information, is propagated at high frequency between devices to continuously reflect the individual load status of the clustered devices. As described in Bare (U.S. Pat. No. 6,493,318) for example, protocol data packets can be richly detailed with information to define and manage the propagation of the load information and to further detail the load status of individual devices within the cluster. Sequence numbers, hop counts, and various flog-bits are used in support of spanning tree-type information distribution algorithms to control protocol packet propagation and prevent loop-bocks. The published load values are defined in terms of internal throughput rote and latency cost, which allows other clustered routers a more refined basis for determining preferred routing paths. While effective, the custom protocol utilized by the devices described in Bare essentially requires that substantial ports of the load-balancing protocol be implemented in specialized, high-speed hardware, such as network processors. The efficient handling of such protocols is therefore limited to specialized, not general purpose computer systems.

Ballard (U.S. Pat. No. 6,078,960) describes a client/server system architecture that, among other features, effects a client-directed load-balanced use of a server network. For circumstances where the various server computer systems available for use by client computer systems may be provided by independent service providers and where use of the different servers may involve different cost structures, Ballard describes a client-based approach for selectively distributing load from the clients to distinct individual servers within the server network. By implementing client-based load-balancing, the client computer systems in Ballard are essentially independent of the service provider server network implementation.

To implement the Ballard load-balancing system, each client computer system is provided with a server identification list from which servers are progressively selected to receive client requests. The list specifies load control parameters, such as the percentage load and maximum frequency of client requests that are to be issued, for each server identified in the list. Server loads are only roughly estimated by the clients based on the connection time necessary for a request to complete or the amount of data transferred in response to a request. Client requests are then issued by the individual clients to the servers selected as necessary to statistically conform to the load-balancing profile defined by the load control parameters. While the server identification list and included load control parameters are static as held by a client, the individual clients may nonetheless retrieve new server identification lists at various intervals from dedicated storage locations on the servers. Updated server identification lists are distributed to the servers as needed under the manual direction of an administrator. Updating of the server identification lists allows an administrator to manually adjust the load-balance profiles as needed due to changing client requirements and to accommodate the addition and removal of servers from the network.

The static nature of the server identification lists makes the client-based load-balancing operation of the Ballard system fundamentally unresponsive to the actual operation of the server network. While specific server loading can be estimated by the various clients, only complete failures to respond to client requests are detectable and then handled only by excluding a non-responsive server from further participation in servicing client requests. Consequently, under dynamically varying loading conditions, the one sided load-balancing performed by the clients can seriously misapprehend the actual loading of the server network and further exclude servers from participation at least until re-enabled through manual administrative intervention. Such blind exclusion of a server from the server network only increases the load on the remaining servers and the likelihood that other servers will, in turn, be excluded from the server network. Constant manual administrative monitoring of the active server network, including the manual updating of server identification lists to re-enable servers and to adjust the collective client balancing of load on the server network, is therefore required. Such administrative maintenance is quite slow, at least relative to how quickly users will perceive occasions of poor performance, and costly to the point of operational impracticality.

From the forgoing discussion, it is evident that an improved system and methods for cooperatively load-balancing a cluster of servers is needed. There is also a further need, not even discussed in the prior art, for cooperatively managing the configuration of a server cluster, not only with respect to the interoperation of the servers as part of the cluster, but further as a server cluster providing a composite service to external client computer systems. Also, unaddressed is any need for security over the information exchanged between the servers within a cluster. As clustered systems become more widely used for security sensitive purposes, diversion of any portion of the cluster operation through the interception of shared information or introduction of a compromised server into the cluster represents an unacceptable risk.

### SUMMARY OF THE INVENTION

Thus, a general purpose of the present invention is to provide an efficient system and methods of securely coordinating and distributing configuration data among a cluster of network servers to effectively provide a secure system of managing the common configuration of a scalable network service.

This is achieved in the present invention by securely managing communications between server computer systems within a cluster to maintain control over the identification of configuration updates and the distribution of updated configuration data sets. Configuration status messages are routinely exchanged among the servers over a communications network. Each status message identifies any change in the local configuration of a servers and, further, includes encrypted validation data. Each of the servers stores respective configuration data including respective sets of data identifying the servers known to the respective servers as participating in the cluster. Each status message, as received, is validating against the respective configuration data stored by the receiving server. A status message is determined valid when originating from a server as known by the receiving server, as determined from the configuration data held by the receiving server. Where a validated originating server identifies updated configuration data, the receiving server equivalently modifies the locally held configuration data. The configuration of the cluster thus converges on the updated configuration.

Thus, an advantage of the present invention is that acceptance of notice of any update to the configuration data and, further, the acceptance of any subsequently received updated configuration data set is constrained to the set of servers that are mutually known to one another. A receiving server will only accept as valid a message that originates from a server that is already known to the receiving server. Thus, the cluster is a securely closed set of server systems.

Another advantage of the present invention is that, since only light-weight status messages are routinely transmitted among the servers of the cluster, there is minimal processing overhead imposed on the servers to maintain a consistent overall configuration. Updated configuration data sets are transmitted only on demand and generally only occurring after an administrative update is performed.

A further advantage of the present invention is that status messages can serve to both identify the availability of updated configuration sets and to subsequently coordinate the mutual installation of the new configuration data, thereby ensuring consistent operation of the cluster. Configuration version control is also asserted against the host computers to ensure consistent operation.

Still another advantage of the present invention is that both status messages and the transmitted configuration data sets are validated to ensure that they originate from a known participant of the cluster. Receipt validation ensures that rogues and trojans cannot infiltrate the cluster.

Yet another advantage of the present invention is that updated configuration data sets, as encrypted for transmission on demand between servers of the cluster, are further structured to ensure decryption only by a server of the cluster already known to the server that prepares the encrypted, updated configuration data set for transmission.

### BRIEF DESCRIPTION OF THE DRAWINGS

FIG. 1A is a network diagram illustrating a system environment within which host computer systems directly access network services provided by a server cluster in accordance with a preferred embodiment of the present invention.

FIG. 1B is a network diagram illustrating a system environment within which a preferred core network gateway embodiment of the present invention is implemented.

FIG. 2 is a detailed block diagram showing the network interconnection between an array of hosts and a cluster of security processor servers constructed in accordance with a preferred embodiment of the present invention.

FIG. 3 is a detailed block diagram of a security processor server as constructed in accordance with a preferred embodiment of the present invention.

FIG. 4 is a block diagram of a policy enforcement module control process as implemented in a host computer system in accordance with a preferred embodiment of the present invention.

FIG. 5 is a simplified block diagram of a security processor server illustrating the load-balancing and policy update functions shared by a server cluster service provider in accordance with a preferred embodiment of the present invention.

FIG. 6 is a flow diagram of a transaction process cooperatively performed between a policy enforcement module process and a selected cluster server in accordance with a preferred embodiment of the present invention.

FIG. 7A is a flow diagram of a secure cluster server policy update process as performed between the members of a server cluster in accordance with a preferred embodiment of the present invention.

FIG. 7B is a block illustration of a secure cluster server policy synchronization message as defined in accordance with a preferred embodiment of the present invention.

FIG. 7C is a block illustration of a secure cluster server policy data set transfer message data structure as defined in accordance with a preferred embodiment of the present invention.

FIG. 8 is a flow diagram of a process to regenerate a secure cluster server policy data set transfer message in accordance with a preferred embodiment of the present invention.

FIG. 9 is a flow diagram illustrating an extended transaction process performed by a host policy enforcement process to account for a version change in the reported secure cluster server policy data set of a cluster server in accordance with a preferred embodiment of the present invention.

### DETAILED DESCRIPTION OF THE INVENTION

While system architectures have generally followed a client/server paradigm, actual implementations are typically complex and encompass a wide variety of layered network assets. Although architectural generalities are difficult, in all there are fundamentally common requirements of reliability, scalability, and security. As recognized in connection with the present invention, a specific requirement for security commonly exists for at least the core assets, including the server systems and data, of a networked computer system enterprise. The present invention provides for a system and methods of providing a cluster of servers that provide a security service to a variety of hosts established within an enterprise without degrading access to the core assets while maximizing, through efficient load balancing, the utilization of the security server cluster. Those of skill in the art will appreciate that the present invention, while particularly applicable to the implementation of a core network security service, provides fundamentally enables the efficient, load-balanced utilization of a server cluster and, further, enables the efficient and secure administration of the server cluster. As will also be appreciated, in the following detailed description of the preferred embodiments of the present invention, like reference numerals are used to designate like parts as depicted in one ore more of the figures.

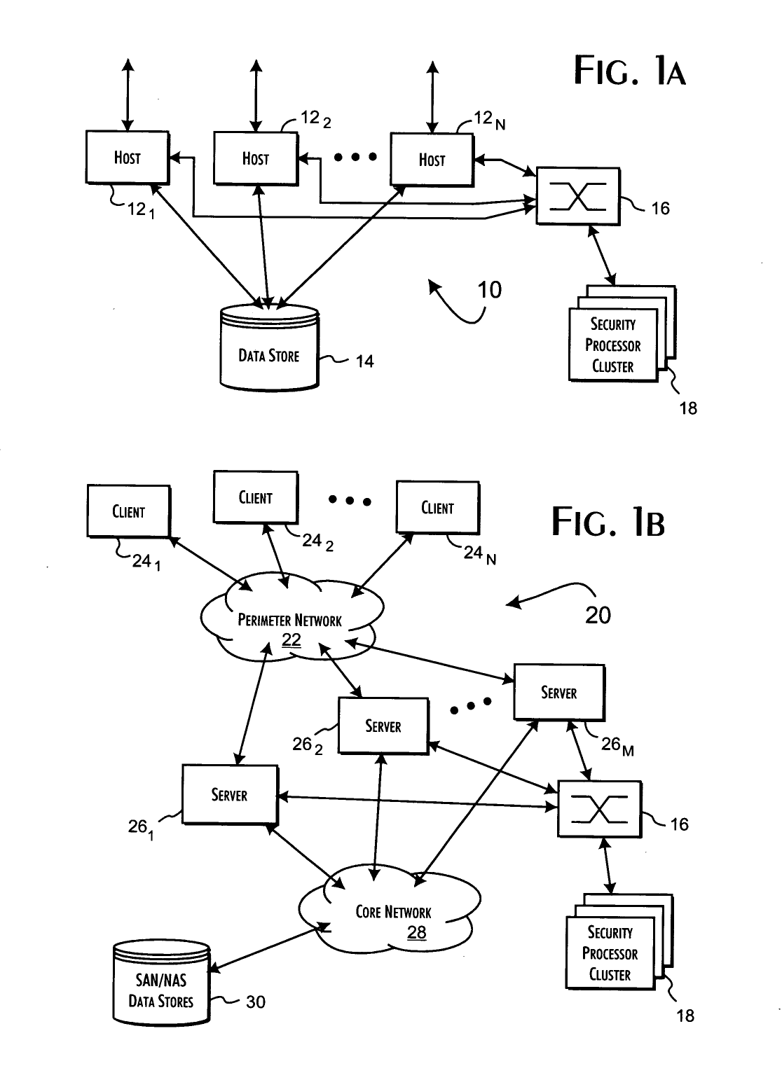

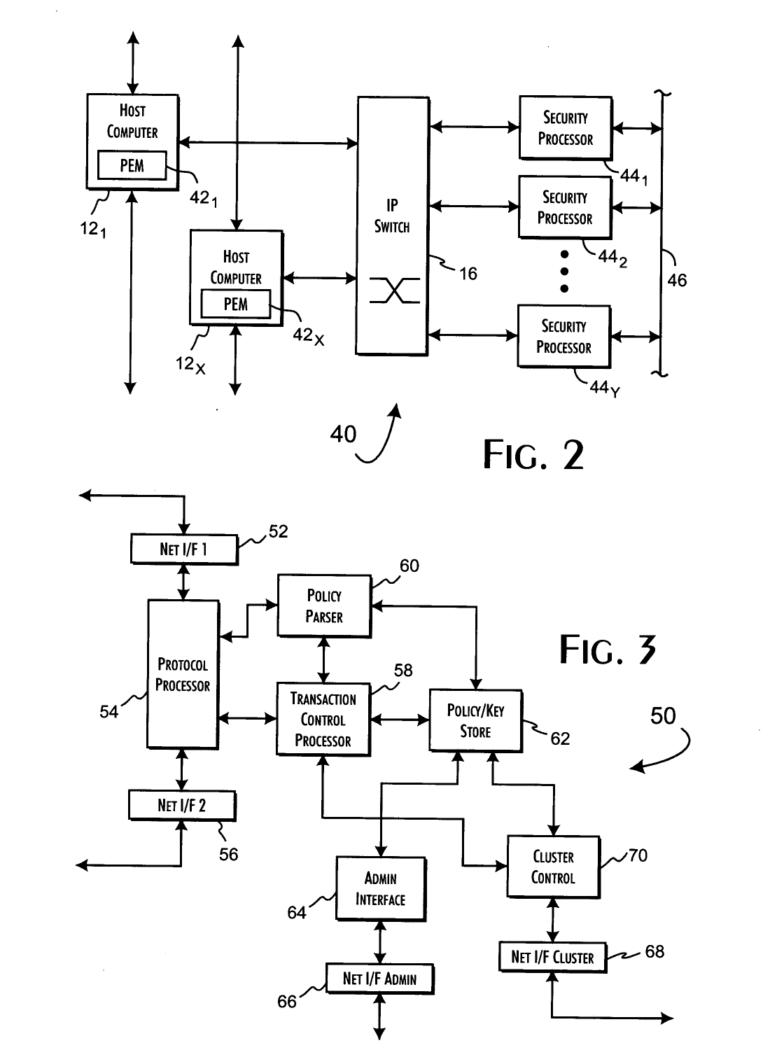

A basic and preferred system embodiment 10 of the present invention is shown in FIG. 1A. Any number of independent host computer systems 12_{1-N} are redundantly connected through a high-speed switch 16 to a security processor cluster 18. The connections between the host computer systems 12_{1-N} the switch 16 and cluster 18 may use dedicated or shared media and may extend directly or through LAN or WAN connections variously between the host computer systems 12_{1-N}, the switch 16 and cluster 18. In accordance with the preferred embodiments of the present invention, a policy enforcement module (PEM) is implemented on and executed separately by each of the host computer systems 12_{1-N}. Each PEM, as executed, is responsible for selectively routing security related information to the security processor cluster 18 to discretely qualify requested operations by or on behalf of the host computer systems 12_{1-N}. For the preferred embodiments of the present invention, these requests represent a comprehensive combination of authentication, authorization, policy-based permissions and common filesystem related operations. Thus, as appropriate, file data read or written with respect to a data store, generically shown as data store 14, is also routed through the security processor cluster 18 by the PEM executed by the corresponding host computer systems 12_{1-N}. Since all of the operations of the PEMs are, in turn, controlled or qualified by the security processor cluster 18, various operations of the host computer systems 12_{1-N} con be securely monitored and qualified.

An alternate enterprise system embodiment 20 of the present invention implementation of the present invention is shown in FIG. 1B. An enterprise network system 20 may include a perimeter network 22 interconnecting client computer systems 24_{1-N} through LAN or WAN connections to at least one and, more typically, multiple gateway servers 26_{1-M} that provide access to a core network 28. Core network assets, such as various back-end servers (not shown), SAN and NAS data stores 30, are accessible by the client computer systems 241-N through the gateway servers 26_{1-M} and core network 28.

In accordance with the preferred embodiments of the present invention, the gateway servers 26_{1-M} may implement both perimeter security with respect to the client computer systems 14_{1-N} and core asset security with respect to the core network 28 and attached network assets 30 within the perimeter established by the gateway servers 26_{1-M}. Furthermore, the gateway servers 26_{1-M} may operate as application servers executing data processing programs on behalf of the client computer systems 24_{1-N}. Nominally, the gateway servers 26_{1-M} are provided in the direct path for the processing of network file requests directed to core network assets. Consequently, the overall performance of the network computer system 10 will directly depend, at least in port, on the operational performance, reliability, and scalability of the gateway servers 26_{1-M}.

In implementing the security service of the gateway servers 26_{1-M}, client requests are intercepted by each of the gateway servers 26_{1-M} and redirected through a switch 16 to a security processor cluster 18. The switch 16 may be a high-speed router fabric where the security processor cluster 18 is local to the gateway servers 26_{1-M}. Alternatively, conventional routers may be employed in a redundant configuration to establish backup network connections between the gateway servers 26_{12-M} and security processor cluster 18 through the switch 16.

For both embodiments 10, 20, shown in FIGS. 1A and 1B, the security processor cluster 18 is preferably implemented as a parallel organized array of server computer systems, each configured to provide a common network service. In the preferred embodiments of the present invention, the provided network service includes a firewall-based filtering of network data packets, including network file data transfer requests, and the selective bidirectional encryption and compression of file data, which is performed in response to qualified network file requests. These network requests may originate directly with the host computer systems 12_{1-N}, client computer systems 14_{1-N}, and gateway servers 16_{1-M} operating as, for example, application servers or in response to requests received by these systems. The detailed implementation and processes carried out by the individual servers of the security processor cluster 18 are described in copending applications Secure Network File Access Control System, Ser. No. 10/201,406, Filed Jul. 22, 2002, Logical Access Block Processing Protocol for Transparent Secure File Storage, Ser. No. 10/201,409, Filed Jul. 22, 2002, Secure Network File Access Controller Implementing Access Control and Auditing, Ser. No. 10/201,358, Filed Jul. 22, 2002, and Secure File System Server Architecture and Methods, Ser. No. 10/271,050, Filed Oct. 16, 2002, all of which are assigned to the assignee of the present invention and hereby expressly incorporated by reference.

The interoperation 40 of an array of host computers 12_{1-X} and the security processor cluster 18 is shown in greater detail in FIG. 2. For the preferred embodiments of the present invention, the host computers 12_{1-X} are otherwise conventional computer systems variously operating as ordinary host computer systems, whether specifically tasked as client computer systems, network proxies, application servers, and database servers. A PEM component 42 is preferably installed and executed on each of the host computers 12₁₋ₓ to functionally intercept and selectively process network requests directed to any local and core data stores 14, 30. In summary, the PEM components 42_{1-X} selectively forward specific requests in individual transactions to target servers 44_{1-Y} within the security processor cluster 18 for policy evaluation and, as appropriate, further servicing to enable completion of the network requests. In forwarding the requests, the PEM components 42_{1-X} preferably operate autonomously. Information regarding the occurrence of a request or the selection of a target server 44 within the security processor cluster 18 is not required to be shored between the PEM components 42_{1-X}, particularly on any time-critical basis. Indeed, the PEM components 42_{1-X} have no required notice of the presence or operation of other host computers 121-X throughout operation of the PEM components 42_{1-X} with respect to the security processor cluster 18.

Preferably, each PEM component 42 is initially provided with a list identification of the individual target servers 44 within the security processor cluster 18. In response to a network request, a PEM component 42_{1-X} selects a discrete target server 44 for the processing of the request and transmits the request through the IP switch 16 to the selected target server 44. Particularly where the PEM component 42_{1-X} executes in response to a local client process, as occurs in the case of application server and similar embodiments, session and process identifier access attributes associated with the client process are collected and provided with the network request. This operation of the PEM component 42_{1-X} is particularly autonomous in that the forwarded network request is preemptively issued to a selected target server 44 with the presumption that the request will be accepted and handled by the designated target server 44.

In accordance with the present invention, a target servers 44 will conditionally accept a network request depending on the current resources available to the target server 44_{1-Y} and a policy evaluation of the access attributes provided with the network request. Lack of adequate processing resources or a policy violation, typically reflecting a policy determined unavailability of a local or core asset against which the request was issued, will result in the refusal of the network request by a target server 44_{1-Y}. Otherwise, the target server 44_{1-Y} accepts the request and performs the required network service.

In response to a network request, irrespective of whether the request is ultimately accepted or rejected, a target server 44_{1-Y} returns load and, optionally, weight information as part of the response to the PEM component 42_{1-X} that originated the network request. The load information provides the requesting PEM component 42 with a representation of the current data processing load on the target server 44_{1-Y}. The weight information similarly provides the requesting PEM component 42_{1-X} with a current evaluation of the policy determined prioritizing weight for a particular network request, the originating host 12 or gateway server 26 associated with the request, set of access attributes, and the responding target server 44_{1-Y}. Preferably, over the course of numerous network request transactions with the security processor cluster 18, the individual PEM components 42_{1-X} will develop preference profiles for use in identifying the likely best target server 44_{1-Y} to use for handling network requests from specific client computer systems 12_{1-N} and gateway servers 26_{1-M}. While load and weight values reported in individual transactions will age with time and may further vary based on the intricacies of individual policy evaluations, the ongoing active utilization of the host computer systems 12_{1-N} permits the PEM components 42_{1-X} to develop and maintain substantially accurate preference profiles that tend to minimize the occurrence of request rejections by individual target servers 44_{1-Y} The load distribution of network requests is thereby balanced to the degree necessary to maximize the acceptance rate of network request transactions.

As with the operation of the PEM components 42_{1-X}, the operation of the target servers 44_{1-Y} are essentially autonomous with respect to the receipt and processing of individual network requests. In accordance with the preferred embodiments of the present invention, load information is not required to be shared between the target servers 44 within the cluster 18, particularly in the critical time path of responding to network requests. Preferably, the target servers 44_{1-Y} uniformly operate to receive any network requests presented and, in acknowledgment of the presented request, identify whether the request is accepted, provide load and optional weight information, and specify at least implicitly the reason for rejecting the request.

While not particularly provided to share load information, a communications link between the individual target servers 44_{1-Y} within the security processor cluster 18 is preferably provided. In the preferred embodiments of the present invention, a cluster local area network 46 is established in the preferred embodiments to allow communication of select cluster management information, specifically presence, configuration, and policy information, to be securely shared among the target servers 44_{1-Y} The cluster local area network 46 communications are protected by using secure sockets layer (SSL) connections and further by use of secure proprietary protocols for the transmission of the management information. Thus, while a separate, physically secure cluster local area network 46 is preferred, the cluster management information may be routed over shared physical networks as necessary to interconnect the target servers 44_{1-Y} of the security processor cluster 18.

Preferably, presence information is transmitted by a broadcast protocol periodically identifying, using encrypted identifiers, the participating target servers 44_{1-Y} of the security processor cluster 18. The security information is preferably transmitted using a lightweight protocol that operates to ensure the integrity of the security processor cluster 18 by precluding rogue or Trojan devices from joining the cluster 18 or compromising the secure configuration of the target servers 44_{1-Y}. A set of configuration policy information is communicated using an additional lightweight protocol that supports controlled propagation of configuration information, including a synchronous update of the policy rules utilized by the individual target servers 44 within the security processor cluster 18. Given that the presence information is transmitted at a low frequency relative to the nominal rate of network request processing, and the security and configuration policy information protocols execute only on the administrative reconfiguration of the security processor cluster 18, such as through the addition of target servers 44_{1-Y} and entry of administrative updates to the policy rule sets, the processing overhead imposed on the individual target servers 44_{1-Y} to support intra-cluster communications is negligible and independent of the cluster loading.

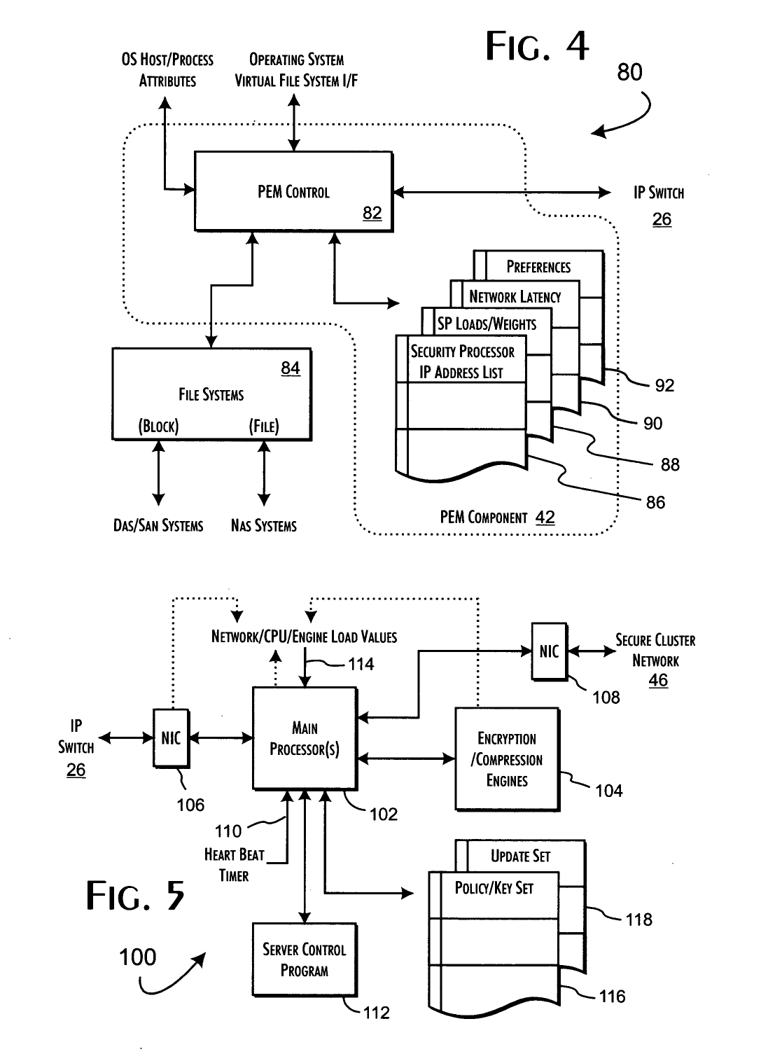

A block diagram and flow representation of the software architecture 50 utilized in a preferred embodiment of the present invention is shown in FIG. 3. Generally inbound network request transactions are processed through a hardware-based network interface controller that supports routeable communications sessions through the switch 16. These inbound transactions are processed through a first network interface 52, a protocol processor 54, and a second network interface 54, resulting in outbound transactions redirected through the host computers 12_{1-X} to local and core data processing and storage assets 14, 30. The same, separate, or multiple redundant hardware network interface controllers can be implemented in each target server 44_{1-Y} and correspondingly used to carry the inbound and outbound transactions through the switch 16.

Network request data packets variously received by a target server from PEM components 42_{1-X}, each operating to initiate corresponding network transactions against local and core network assets 14, 30, are processed through the protocol processor 54 to initially extract selected network and application data packet control information. Preferably, this control information is wrapped in a conventional TCP data packet by the originating PEM component 42_{1-X} for conventional routed transfer to the target server 44_{1-Y}. Alternately, the control information can be encoded as a proprietary RPC data packet. The extracted network control information includes the TCP, IP, and similar networking protocol layer information, while the extracted application information includes access attributes generated or determined by operation of the originating PEM component 42_{1-X} with respect to the particular client processes and context within which the network request is generated. In the preferred embodiments of the present invention, the application information is a collection of access attributes that directly or indirectly identifies the originating host computer, user and domain, application signature or security credentials, and client session and process identifiers, as available, for the host computer 12_{1-N} that originates the network request. The application information preferably further identifies, as available, the status or level of authentication performed to verify the user. Preferably, a PEM component 42_{1-X} automatically collects the application information into a defined data structure that is then encapsulated as a TCP network data packet for transmission to a target server 44_{1-Y}.

Preferably, the network information exposed by operation of the protocol processor 54 is provided to a transaction control processor 58 and both the network and application control information is provided to a policy parser 60. The transaction control processor 58 operates as a state machine that controls the processing of network data packets through the protocol processor 54 and further coordinates the operation of the policy parser in receiving and evaluating the network and application information. The transaction control processor 58 state machine operation controls the detailed examination of individual network data packets to locate the network and application control information and, in accordance with the preferred embodiments of the present invention, selectively control the encryption and compression processing of an enclosed data payload. Network transaction state is also maintained through operation of the transaction control processor 58 state machine. Specifically, the sequences of the network data packets exchanged to implement network file data read and write operations, and other similar transactional operations, are tracked as necessary to maintain the integrity of the transactions while being processed through the protocol processor 54.

In evaluating a network data packet identified by the transaction control processor 58 as an initial network request, the policy parser 60 examines selected elements of the available network and application control information. The policy parser 60 is preferably implemented as a rule-based evaluation engine operating against a configuration policy/key data set stored in a policy/key store 62. The rules evaluation preferably implements decision tree logic to determine the level of host computer 12_{1-N} authentication required to enable processing the network file request represented by the network file data packet received, whether that level of authentication has been met, whether the user of a request initiating host computer 12_{1-N} is authorized to access the requested core network assets, and further whether the process and access attributes provided with the network request are adequate to enable access to the specific local or core network resource 14, 30 identified in the network request.

In a preferred embodiment of the present invention, the decision tree logic evaluated in response to a network request to access file data considers user authentication status, user access authorization, and access permissions. Authentication of the user is considered relative to a minimum required authentication level defined in the configuration policy/key data set against a combination of the identified network request core network asset, mount point, target directory and file specification. Authorization of the user against the configuration policy/key data set is considered relative to a combination of the particular network file request, user name and domain, client IP, and client session and client process identifier access attributes. Finally, access permissions are determined by evaluating the user name and domains, mount point, target directory and file specification access attributes with correspondingly specified read/modify/write permission data and other available file related function and access permission constraints as specified in the configuration policy/key data set.

Where PEM components 42_{1-X} function as filesystem proxies, useful to map and redirect filesystem requests for virtually specified data stores to particular local and core network file system data stores 14, 30, data is also stored in the policy/key store 62 to define the set identity of virtual file system mount points accessible to host computer systems 12_{1-N} and the mapping of virtual mount points to real mount points. The policy data can also variously define permitted host computer source IP ranges, whether application authentication is to be enforced as a prerequisite for client access, a limited, permitted set of authenticated digital signatures of authorized applications, whether user session authentication extends to spawned processes or processes with different user name and domain specifications, and other attribute data that can be used to match or otherwise discriminate, in operation of the policy parser 60, against application information that can be marshaled on demand by the PEM components 42_{1-X} and network information.

In the preferred embodiments of the present invention, encryption keys are also stored in the policy/key store 62. Preferably, individual encryption keys, as well as applicable compression specifications, are maintained in a logically hierarchical policy set rule structure parseable as a decision tree. Each policy rule provides an specification of some combination of network and application attributes, including the access attributed defined combination of mount point, target directory and file specification, by which permissions constraints on the further processing of the corresponding request can be discriminated. Based on a pending request, a corresponding encryption key is parsed by operation of the policy parser 60 from the policy rule set as needed by the transaction control processor 58 to support the encryption and decryption operations implemented by the protocol processor subject. For the preferred embodiments of the present invention, policy rules and related key data are stored in a hash table permitting rapid evaluation against the network and application information.

Manual administration of the policy data set data is performed through an administration interface 64, preferably accessed over a private network and through a dedicated administration network interface 66. Updates to the policy data set are preferably exchanged autonomously among the target servers 44_{1-Y} of the security processor cluster 18 through the cluster network 46 accessible through a separate cluster network interface 68. A cluster policy protocol controller 70 implements the secure protocols for handling presence broadcast messages, ensuring the security of the cluster 46 communications, and exchanging updates to the configuration policy/key data set data.

On receipt of a network request, the transaction control processor 58 determines whether to accept or reject the network request dependent on the evaluation performed by the policy parser 60 and the current processing load values determined for the target server 44. A policy parser 60 based rejection will occur where the request fails authentication, authorization, or permissions policy evaluation. For the initially preferred embodiments of the present invention, rejections are not issued for requests received in excess of the current processing capacity of a target server 44. Received requests are buffered and processed in order of receipt with an acceptable increase in the request response latency. The load value immediately returned in response to a request that is buffered will effectively redirect subsequent network requests from the host computers 12_{1-N} to other target servers 44_{1-Y}. Alternately, any returned load value can be biased upward by a small amount to minimize the receipt of network requests that are actually in excess of the current processing capacity of a target server 44. In an alternate embodiment of the present invention, an actual rejection of a network request may be issued by a target server 44_{1-Y} to expressly preclude exceeding the processing capacity of a target server 44_{1-Y}. A threshold of, for example, 95% load capacity can be set to define when subsequent network requests are to be refused.

To provide the returned load value, a combined load value is preferably computed based on a combination of individual load values determined for the network interface controllers connected to the primary network interfaces 52, 56, main processors, and hardware-based encryption/compression coprocessors employed by a target server 44. This combined load value and, optionally, the individual component load values are returned to the request originating host computer 12_{1-N} in response to the network request. Preferably, at least the combined load value is preferably projected to include handling of the current network request. Depending then on the applicable load policy rules governing the operation of the target server 44_{1-Y}, the response returned signals either an acceptance or rejection of the current network request.

In combination with authorization, authentication and permissions evaluation against the network request, the policy parser 60 optionally determines a policy set weighting value for the current transaction, preferably irrespective of whether the network request is to be rejected. This policy determined weighting value represents a numerically-based representation of the appropriateness for use of a particular target server 44 relative to a particular a network request and associated access attributes. For a preferred embodiment of the present invention, a relative low value in a normalized range of 1 to 100, indicating preferred use, is associated with desired combinations of acceptable network and application information. Higher values are returned to identify generally backup or alternative acceptable use. A preclusive value, defined as any value above a defined threshold such as 90, is returned as an implicit signal to a PEM component 42_{1-X} that corresponding network requests are not to be directed to the specific target server 44 except under exigent circumstances.

In response to a network request, a target server 44 returns the reply network data packet including the optional policy determined weighting value, the set of one or more load values, and an identifier indicating the acceptance or rejection of the network request. In accordance with the preferred embodiments of the present invention, the reply network data packet may further specify whether subsequent data packet transfers within the current transaction need be transferred through the security processor cluster 18. Nominally, the data packets of an entire transaction are routed through a corresponding target server 44 to allow for encryption and compression processing. However, where the underlying transported file data is not encrypted or compressed, or where any such encryption or compression is not to be modified, or where the network request does not involve a file data transfer, the current transaction transfer of data need not route the balance of the transaction data packets through the security processor cluster 18. Thus, once the network request of the current transaction has been evaluated and approved by the policy parser 60 of a target server 44, and an acceptance reply packet returned to the host computer 12_{1-N}, the corresponding PEM component 42_{1-X} can selectively bypass use of the security processor cluster 18 for the completion of the current transaction.

An exemplary representation of a PEM component 42, as executed, is shown 80 in FIG. 4. A PEM control layer 82, executed to implement the control function of the PEM component 42, is preferably installed on a host system as a kernel component under the operating system virtual file system switch or equivalent operating system control structure. In addition to supporting a conventional virtual file system switch interface to the operating system kernel, the PEM control layer 82 preferably implements some combination of a native or network file system or an interface equivalent to the operating system virtual file system switch interface through which to support internal or operating system provided file systems 84. Externally provided file systems 84 preferably include block-oriented interfaces enabling connection to direct access (DAS) and storage network (SAN) data storage assets and file-oriented interfaces permitting access to network-attached storage (NAS) network data storage assets.

The PEM control layer 82 preferably also implements an operating system interface that allows the PEM control layer 82 to obtain the hostname or other unique identifier of the host computer system 12, the source session and process identifiers corresponding to the process originating a network file request as received through the virtual file system switch, and any authentication information associated with the user name and domain for the process originating the network file request. In the preferred embodiments of the present invention, these access attributes and the network file request as received by the PEM control layer 82 are placed in a data structure that is wrapped by a conventional TCP data pocket. This effectively proprietary TCP data packet is then transmitted through the IP switch 16 to present the network request to a selected target server 44. Alternately, a conventional RPC structure could be used in place of the proprietary data structure.

The selection of the target server 44 is performed by the PEM control layer 82 based on configuration and dynamically collected performance information. A security processor IP address list 86 provides the necessary configuration information to identify each of the target servers 44_{1-Y} within the security processor cluster 18. The IP address list 86 can be provided manually through a static initialization of the PEM component 42 or, preferably, is retrieved as part of an initial configuration data set on an initial execution of the PEM control layer 82 from a designated or default target server 44_{1-Y} of the security processor cluster 18. In the preferred embodiment of the present invention, each PEM component 42_{1-X}, in initial execution, implements an authentication transaction against the security processor cluster 18 through which the integrity of the executing PEM control layer 82 is verified and the initial configuration data, including an IP address list 86, is provided to the PEM component 421

Dynamic information, such as the server load and weight values, is progressively collected by an executing PEM component 42_{1-X} into a SP loads/weights table 88. The load values are timestamped and indexed relative to the reporting target server 44. The weight values are similarly timestamped and indexed. For an initial preferred embodiment, PEM component 42 utilizes a round-robin target server 44_{1-Y} selection algorithm, where selection of a next target server 44_{1-Y} occurs whenever the loading of a current target server 44_{1-Y} reaches 100%. Alternately, the load and weight values may be further inversely indexed by any available combination of access attributes including requesting host identifier, user name, domain, session and process identifiers, application identifiers, network file operation requested, core network asset reference, and any mount point, target directory and file specification. Using a hierarchical nearest match algorithm, this stored dynamic information allows a PEM component 42_{1-X} to rapidly establish an ordered list several target servers 44_{1-Y} that are both least loaded and most likely to accept a particular network request. Should the first identified target server 44_{1-Y} reject the request, the next listed target server 44, is tried.

A network latency table 90 is preferably utilized to store dynamic evaluations of network conditions between the PEM control layer 82 and each of the target servers 44_{1-Y}. Minimally, the network latency table 90 is used to identify those target servers 44_{1-Y} that no longer respond to network requests or are otherwise deemed inaccessible. Such unavailable target servers 44_{1-Y} are automatically excluded from the target servers selection process performed by the PEM control layer 82. The network latency table 90 may also be utilized to store timestamped values representing the response latency times and communications cost of the various target servers 44_{1-Y}. These values may be evaluated in conjunction with the weight values as part of the process of determining and ordering of the target servers 44_{1-Y} for receipt of new network requests.

Finally, a preferences table 92 may be implemented to provide a default traffic shaping profile individualized for the PEM component 42_{1-X}. For an alternate embodiment of the present invention, a preferences profile may be assigned to each of the PEM components 42_{1-X} to establish a default allocation or partitioning of the target servers 44_{1-Y} within a security processor cluster 18. By assigning target servers 44_{1-Y} different preference values among the PEM components 42₁₋ₓ and further evaluating these preference values in conjunction with the weight values, the network traffic between the various host computers 12_{1-N} and individual target servers 44_{1-Y} can be used to flexibly define use of particular target servers 44_{1-Y}. As with the IP address list 86, the contents of the preferences table may be provided by manual initialization of the PEM control layer 82 or retrieved as configuration data from the security processor cluster 18.

A preferred hardware server system 100 for the target servers 44_{1-Y} is shown in FIG. 5. In the preferred embodiments of the present invention, the software architecture 50, as shown in FIG. 3, is substantially executed by one or more main processors 102 with support from one or more peripheral, hardware-based encryption/compression engines 104. One or more primary network interface controllers (NICs) 106 provide a hardware interface to the IP switch 16. Other network interface controllers, such as the controller 108, preferably provide separate, redundant network connections to the secure cluster network 46 and to an administrator console (not shown). A heartbeat timer 110 preferably provides a one second interval interrupt to the main processors to support maintenance operations including, in particular, the secure cluster network management protocols.

The software architecture 50 is preferably implemented as a server control program 112 loaded in and executed by the main processors 102 from the main memory of the hardware server system 100. In executing the server control program 112, the main processors 102 preferably perform on-demand acquisition of load values for the primary network interface controller 106, main processors 102, and the encryption/compression engines 104. Depending on the specific hardware implementation of the network interface controller 106 and encryption/compression engines 104, individual load values may be read 114 from corresponding hardware registers. Alternately, software-based usage accumulators may be implemented through the execution of the server control program 112 by the main processors 102 to track throughput use of the network interface controller 106 and current percentage capacity processing utilization of the encryption/compression engines 104. In the initially preferred embodiments of the present invention, each of the load values represents the percentage utilization of the corresponding hardware resource. The execution of the server control program 112, also provides for establishment of a configuration policy/key data set 116 table also preferably within the main memory of the hardware server system 100 and accessible to the main processors 102. A second table 118 is similarly maintained to receive an updated configuration policy/key data set through operation of the secure cluster network 46 protocols.

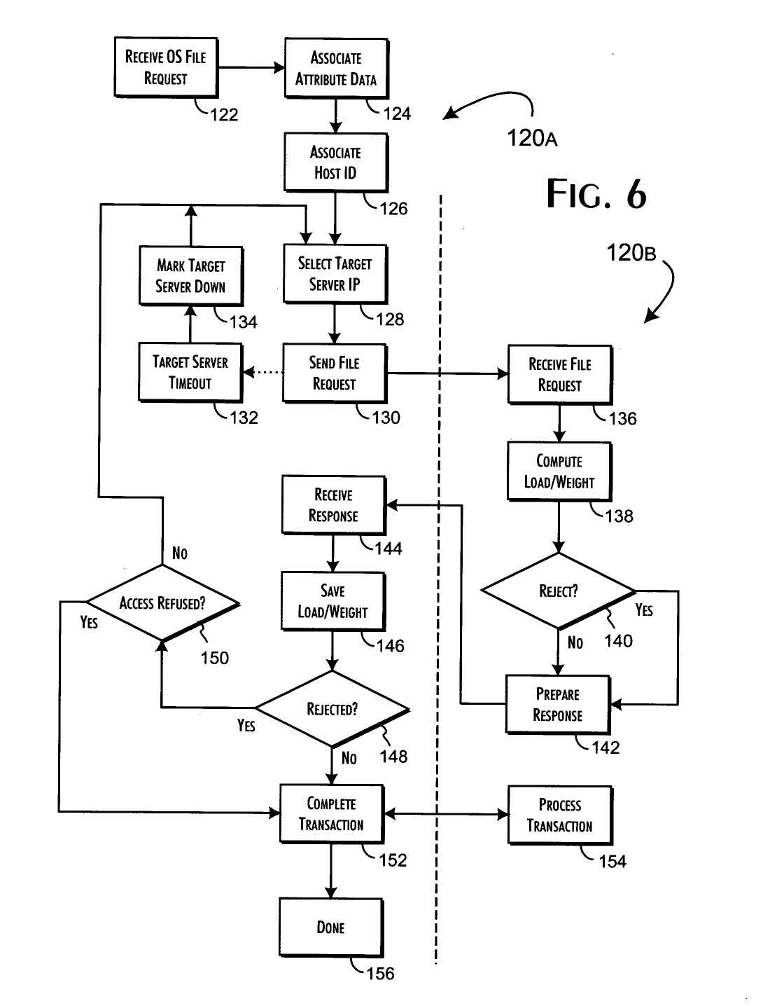

FIG. 6 provides a process flow diagram illustrating the load-balancing operation 120A implemented by a PEM component 42_{1-X} as executed on a host computer 12_{1-N} cooperatively 120B with a selected target server 44 of the security processor cluster 18. On receipt 122 of a network request from a client 14, typically presented through the virtual filesystem switch to the PEM component 42_{1-X} as a filesystem request, the network request is evaluated by the PEM component 42_{1-X} to associate available access attributes 124, including the unique host identifier 126, with the network request. The PEM component 42_{1-X} then selects 128 the IP address of a target server 44 from the security processor cluster 18.

The proprietary TCP-based network request data pocket is then constructed to include the corresponding network request and access attributes. This network request is then transmitted 130 through the IP switch 16 to the target server 44. A target server response timeout period is set concurrently with the transmission 130 of the network request. On the occurrence of a response timeout 132, the specific target server 44 is marked in the network latency table 90 as down or otherwise non-responsive 134. Another target server 44 is then selected 128 to receive the network request. Preferably, the selection process is reexecuted subject to the unavailability of the non-responsive target server 44. Alternately, the ordered succession of target servers identified upon initial receipt of the network request may be transiently preserved to support retries in the operation of the PEM component 42_{1-X}. Preservation of the selection list at least until the corresponding network request is accepted by a target server 44 allows a rejected network request to be immediately retried to the next successive target server without incurring the overhead of reexecuting the target server 44 selection process 128. Depending on the duration of the response timeout 132 period, however, re-use of a selection list may be undesirable since any intervening dynamic updates to the security processor loads and weights table 88 and network latency table 90 will not be considered, potentially leading to a higher rate of rejection on retries. Consequently, reexecution of the target server 44 selection process 128 taking into account all data in the security processor loads and weights table 88 and network latency table 90 is generally preferred.

On receipt 120B of the TCP-based network request 136, a target server 44 initially examines the network request to access to the request and access attribute information. The policy parser 60 is invoked 138 to produce a policy determined weight value for the request. The load values for the relevant hardware components of the target server 44 are also collected. A determination is then made of whether to accept or reject 140 the network request. If the access rights under the policy evaluated network and application information precludes the requested operation, the network request is rejected. For embodiments of the present invention that do not automatically accept and buffer in all permitted network requests, the network request is rejected if the current load or weight values exceed the configuration established threshold load and weight limits applicable to the target server 44_{1-Y}. In either event, a corresponding request reply data packet is generated 142 and returned.

The network request reply is received 144 by the request originating host computer 12_{1-N} and passed directly to the locally executing PEM component 42_{1-X}. The load and any returned weight values are timestamped and saved to the security processor loads and weights table 88. Optionally, the network latency between the target server 44 and host computer 12_{1-N}, determined from the network request response data packet, is stored in the network latency table 90. If the network request is rejected 148 based on insufficient access attributes 150, the transaction is correspondingly completed 152 with respect to the host computer 12_{1-N}. If rejected for other reasons, a next target server 44 is selected 128. Otherwise, the transaction confirmed by the network request reply is processed through the PEM component 42_{1-X} and, as appropriate, transferring network data packets to the target server 44 as necessary for data payload encryption and compression processing 154. On completion of the client requested network file operation 152, the network request transaction is complete 156.

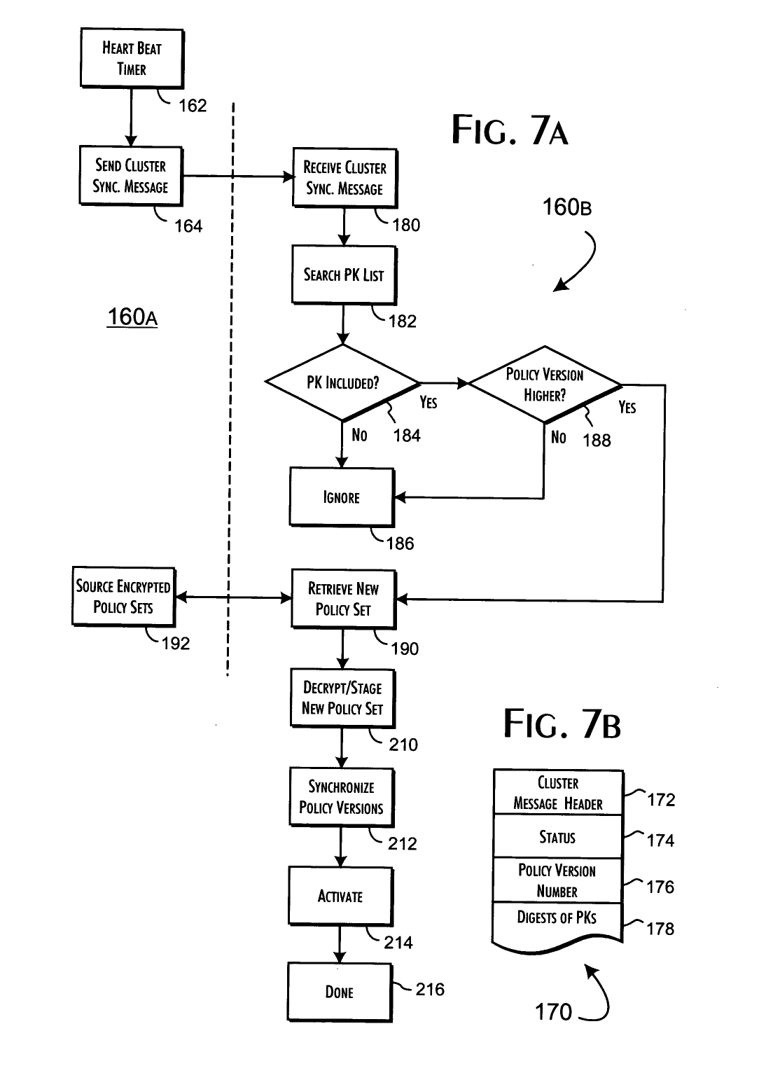

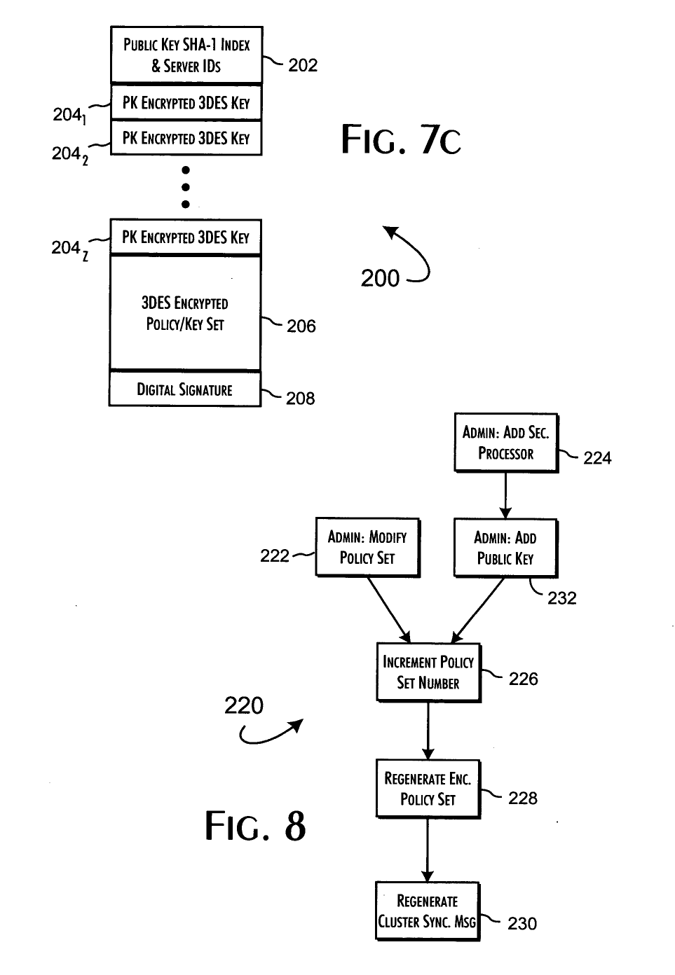

The preferred secure process 160A/160B for distributing presence information and responsively transferring configuration data sets, including the configuration policy/key data, among the target servers 44 of a security processor cluster 18 is generally shown in FIG. 7A. In accordance with the preferred embodiments of the present invention, each target server 44 transmits various cluster messages on the secure cluster network 46. Preferably, a cluster message 170, generally structured as shown in FIG. 7B, includes a cluster message header 172 that defines a message type, header version number, target server 44_{1-Y} identifier or simply source IP address, sequence number, authentication type, and a checksum. The cluster message header 172 further includes a status value 174 and a current policy version number 146, representing the assigned version number of the most current configuration and configuration policy/key data set held by the target server 44 transmitting the cluster message 170. The status value 174 is preferably used to define the function of the cluster message. The status types include discovery of the set of target servers 44_{1-Y} within the cluster, the joining, leaving and removal of target servers 44_{1-Y} from the cluster, synchronization of the configuration and configuration policy/key data sets held by the target servers 44_{1-Y}, and, where redundant secure cluster networks 46 are available, the switch to a secondary secure cluster network 46.

The cluster message 170, also includes a PK digest 178 that contains a structured list including a secure hash of the public key, the corresponding network IP, and a status field for each target server 44, of the security processor cluster 18, as known by the particular target server 44 originating a cluster message 170. Preferably, a secure hash algorithm, such as SHA-1, is used to generate the secure public key hashes. The included status field reflects the known operating state of each target server 44, including synchronization in progress, synchronization done, cluster join, and cluster leave states.

Preferably, the cluster message header 172 also includes a digitally signed copy of the source target server 44 identifier as a basis for assuring the validity of a received cluster message 170. Alternately, a digital signature generated from the cluster message header 172 can be appended to the cluster message 170. In either case, a successful decryption and comparison of the source target server 44 identifier or secure hash of the cluster message header 72 enables a receiving target server 44 to verify that the cluster message 170 is from a known source target server 44 and, where digitally signed, has not been tampered with.

For the preferred embodiments of the present invention, the target servers 44_{1-Y} of a cluster 18 maintain essentially a common configuration to ensure a consistent operating response to any network request made by any host computer 12_{1-X}. To ensure synchronization the configuration of the target servers 44_{1-Y}, cluster synchronization messages are periodically broadcast 160A on the secure cluster network 46 by each of the target servers 44_{1-Y}, preferably in response to a hardware interrupt generated by the local heartbeat timer 162. Each cluster synchronization message is sent 164 in a cluster message 170 with a synchronization status 174 value, the current policy version level 176 of the cluster 18, and the securely recognizable set of target servers 44 permitted to participate in the security processor cluster 18, specifically from the frame of reference of the target server 44 originating the cluster synchronization message 170.

Each target server 44 concurrently processes 160B broadcast cluster synchronization messages 170 as received 180 from each of the other active target servers 44_{1-Y} on the secure cluster network 46. As each cluster synchronization message 170 is received 180 and validated as originating from a target server 44 known to validly exist in the security processor cluster 18, the receiving target server 44 will search 182 the digests of public keys 176 to determine whether the public key of the receiving target server is contained within the digest list 176. If the secure hash equivalent of the public key of a receiving target server 44 is not found 184, the cluster synchronization message 170 is ignored 186. Where the secure hashed public key of the receiving target server 44 is found in a received cluster synchronization message 170, the policy version number 174 is compared to the version number of the local configuration policy/key data set held by the receiving target server 44. If the policy version number 174 is the same or less than that of the local configuration policy/key data set, the cluster synchronization message 170 is again ignored 186.

Where the policy version number 174 identified in a cluster synchronization message 170 is greater than that of the current active configuration policy/key data set, the target server 44 issues a retrieval request 190, preferably using an HTTPs protocol, to the target server 44 identified within the corresponding network data packet as the source of the cluster synchronization message 170. The comparatively newer configuration policy/key data set held by the identified source target server 44 is retrieved to update the configuration policy/key data set held by the receiving target server 44. The identified source target server 44 responds 192 by returning a source encrypted policy set 200.

As generally detailed in FIG. 7c, a source encrypted policy set 200 is preferably a defined data structure containing an index 202, a series of encrypted access keys 204_{1-Z}, where Z is the number of target servers 44_{1-Y} known by the identified source target server 44 to be validly participating in security processor cluster 18, an encrypted configuration policy/key data set 206, and a policy set digital signature 208. Since the distribution of configuration policy/key data sets 206 may occur successively among the target servers 44_{1-Y}, the number of valid participating target servers 44_{1-Y} may vary from the viewpoint of different target servers 44_{1-Y} of the security processor cluster 18 while a new configuration policy/key data set version is being distributed.

The index 202 preferably contains a record entry for each of the known validly participating target servers 44_{1-Y}. Each record entry preferably stores a secure hash of the public key and an administratively assigned identifier of a corresponding target server 44_{1-Y}. By convention, the first listed record entry corresponds to the source target server 44 that generated the encrypted policy set 200. The encrypted access keys 204_{1-Z} each contain the same triple-DES key, through encrypted with the respective public keys of the known validly participating target servers 44_{1-Y}. The source of the public keys used in encrypting the triple-DES key is the locally held configuration policy/key data set. Consequently, only those target servers 44_{1-Y} that are validly known to the target server 44 that sources an encrypted policy set 200 will be able to first decrypt a corresponding triple-DES encryption key 204_{1-Z} and then successfully decrypt the included configuration policy/key data set 206.

A new triple-DES key is preferably generated using a random function for each policy version of an encrypted policy set 200 constructed by a particular target servers 44_{1-Y}. Alternately, new encrypted policy sets 200 can be reconstructed, each with a different triple-DES key, in response to each HTTPs request received by a particular target servers 44_{1-Y}. The locally held configuration policy/key data set 206 is triple-DES encrypted using the current generated triple-DES key. Finally, a digital signature 208, generated based on a secure hash of the index 202 and list of encrypted access keys 204_{1-Z}, is appended to complete the encrypted policy set 200 structure. The digital signature 208 thus ensures that the source target server 44 identified by the initial secure hash/identifier pair record is in fact the valid source of the encrypted policy set 200.

Referring again to FIG. 7A, on retrieval 190 of a source encrypted policy set 200 and further validation as secure and originating from a target server 44 known to validly exist in the security processor cluster 18, the receiving target server 44 searches the public key digest index 202 for digest value matching the public key of the receiving target server 44. Preferably, the index offset location of the matching digest value is used as a pointer to the data structure row containing the corresponding public key encrypted triple-DES key 206 and triple-DES encrypted configuration policy/key data set 204. The private key of the receiving target server 44 is then utilized 210 to recover the triple-DES key 206 that is then used to decrypt the configuration policy/key data set 204. As decrypted, the relatively updated configuration policy/key data set 204 is transferred to and held in the update configuration policy/key data set memory 118 of the receiving target server 44. Pending installation of the updated configuration policy/key data set 204, a target server 44 holding a pending updated configuration policy/key data set resumes periodic issuance of cluster synchronization messages 170, though using the updated configuration policy/key data set version number 174.

In accordance with the preferred embodiments of the present invention, updated configuration policy/key data sets 204 are relatively synchronously installed as current configuration policy/key data sets 116 to ensure that the active target servers 44_{1-Y} of the security processor cluster 18 are concurrently utilizing the same version of the configuration policy/key data set. Effectively synchronized installation is preferably obtained by having each target server 44 wait 212 to install an updated configuration policy/key data set 204 by monitoring cluster synchronization messages 170 until all such messages contain the same updated configuration policy/key data set version number 174. Preferably, a threshold number of cluster synchronization messages 170 must be received from each active target server 44, defined as those valid target servers 44_{1-Z} that have issued a cluster synchronization message 170 within a defined time period, for a target server 44 to conclude to install an updated configuration policy/key data set. For the preferred embodiments of the present invention, the threshold number of cluster synchronization messages 170 is two. From the perspective of each target server 44, as soon as all known active target servers 44_{1-Y} are recognized as having the same version configuration policy/key data set, the updated configuration policy/key data set 118 is installed 214 as the current configuration policy/key data set 116. The process 1608 of updating of a local configuration policy/key data set is then complete 216.

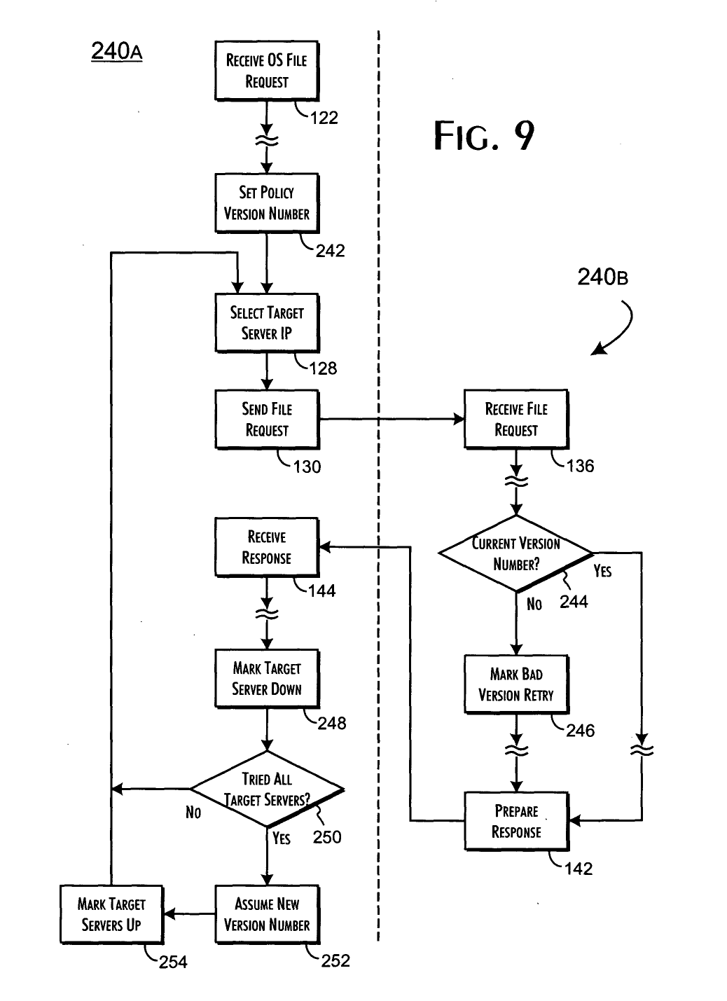

Referring to FIG. 8, an updated configuration policy/key data set is generated 220 ultimately as a result of administrative changes made to any of the information stored as the local configuration policy/key set data. Administrative changes 222 may be made to modify access rights and similar data principally considered in the policy evaluation of network requests. Changes may also be made as a consequence of administrative reconfiguration 224 of the security processor cluster 18, typically due to the addition or removal of a target server 44. In accordance with the preferred embodiments of the present invention, administrative changes 222 are made by an administrator by access through the administration interface 64 on any of the target servers 44_{1-Y}. The administrative changes 222, such as adding, modifying, and deleting policy rules, changing encryption keys for select policy rule sets, adding and removing public keys for known target servers 44, and modifying the target server 44 IP address lists to be distributed to the client computers 12, when made and confirmed by the administrator, are committed to the local copy of the configuration policy/key data set. On committing the changes 222, the version number of the resulting updated configuration policy/key data set is also automatically incremented 226. For the preferred embodiments, the source encrypted configuration policy/key data set 200 is then regenerated 228 and held pending transfer requests from other target servers 44_{1-Y}. The cluster synchronization message 170 is also preferably regenerated to contain the new policy version number 174 and corresponding digest set of public keys 176 for broadcast in nominal response to the local heartbeat timer 162. Consequently, the newly updated configuration policy/key data set will be automatically distributed and relatively synchronously installed on all other active target servers 44_{1-Y} of the security processor cluster 18.

A reconfiguration of the security processor cluster 18 requires a corresponding administrative change to the configuration policy/key data set to add or remove a corresponding public key 232. In accordance with the preferred embodiments of the present invention, the integrity of the security processor cluster 18 is preserved as against rogue or Trojan target servers 44_{1-Y} by requiring the addition of a public key to a configuration policy/key data set to be mode only by a locally authenticated system administrator or through communications with a locally known valid and active target server 44 of the security processor cluster 18. Specifically, cluster messages 170 from target servers 44 not already identified by a corresponding public key in the installed configuration policy/key data set of a receiving target server 44 re ignored. The public key of a new target server 44 must be administratively entered 232 on another known and valid target server to be, in effect, securely sponsored by that existing member of the security processor cluster 18 in order for the new target server 44 to be recognized.

Consequently, the present invention effectively precludes a rogue target server from self-identifying a new public key to enable the rogue to join the security processor cluster 18. The administration interface 64 on each target server 44 preferably requires a unique, secure administrative login in order to make administrative changes 222, 232 to a local configuration policy/key data set. An intruder attempting to install a rogue or Trojan target server 44 must have both access to and specific security pass codes for an existing active target server 44 of the security processor cluster 18 in order to be possibly successful. Since the administrative interface 64 is preferably not physically accessible from the perimeter network 12, core network 18, or cluster network 46, an external breach of the security over the configuration policy/key data set of the security processor cluster 18 is fundamentally precluded.

In accordance with the preferred embodiments of the present intention, the operation of the PEM components 42_{1-X}, on behalf of the host computer systems 12_{1-X}, is also maintained consistent with the version of the configuration policy/key data set installed on each of the target servers 44_{1-Y} of the security processor cluster 18. This consistency is maintained to ensure that the policy evaluation of each host computer 12 network request is handled seamlessly irrespective of the particular target server 44 selected to handle the request. As generally shown in FIG. 9, the preferred execution 240A of the PEM components 42_{1-X} operates to track the current configuration policy/key data set version number. Generally consistent with the PEM component 42 execution 120A, following receipt of a network request 122, the last used policy version number held by the PEM component 42_{1-X} is set 242 with the IP address of the selected target server 44, as determined through the target server selection algorithm 128, in the network request data packet. The last used policy version number is set to zero, as is by default the case on initialization of the PEM component 42_{1-X}, to a value based on initializing configuration data provided by a target server 44 of the security processor cluster 18, or to a value developed by the PEM component 42_{1-X} through the cooperative interaction with the target servers 44 of the security processor cluster 18. The network request data packet is then sent 130 to the chosen target server 44.

The target server 44 process execution 240B is similarly consistent with the process execution 120B nominally executed by the target servers 44_{1-Y}. Following receipt of the network request data packet 136, an additional check 244 is executed to compare the policy version number provided in the network request with that of the currently installed configuration policy/key data set. If the version number presented by the network request is less than the installed version number, a bad version number flog is set 246 to force generation of a rejection response 142 further identifying the version number mismatch as a reason for the rejection. Otherwise, the network request is processed consistent with the procedure 120B. Preferably, the target server process execution 240B also provides the policy version number of the locally held configuration policy/key data set in the request reply data packet irrespective of whether a bad version number rejection response 142 is generated.

On receipt 144 specifically of a version number mismatch rejection response, a PEM component 42_{1-X} preferably updates the network latency table 90 to mark 248 the corresponding target server 44 as down due to a version number mismatch. Preferably, the reported policy version number is also stored in the network latency table 90. A retry selection 128 of a next target server 44 is then performed unless 250 all target servers 44 are then determined unavailable based on the combined information stored by the security processor IP address list 86 and network latency table 90. The PEM component 42_{1-X} then assumes 252 the next higher policy version number as received in a bad version number rejection response 142. Subsequent network requests 122 will also be identified 242 with this new policy version number. The target servers 44_{1-Y} previously marked down due to version number mismatches are then marked up 254 in the network latency table 90. A new target server 44 selection is then made 128 to again retry the network request utilizing the updated policy version number. Consequently, each of the PEM components 42 will consistently track changes made to the configuration policy/key data set in use by the security processor cluster 18 and thereby obtain consistent results independent of the particular target server 44 chosen to service any particular network request.

Thus, a system and methods for cooperatively load-balancing a cluster of servers to effectively provide a reliable, scalable network service has been described. While the present invention has been described particularly with reference to a host-based, policy enforcement module inter-operating with a server cluster, the present invention is equally applicable to other specific architectures by employing a host computer system or host proxy to distribute network requests to the servers of a server cluster through cooperative interoperation between the clients and individual servers. Furthermore, while the server cluster service has been described as a security, encryption, and compression service, the system and methods of the present invention are generally applicable to server clusters providing other network services. Also, while the server cluster has been describes as implementing a single, common service, such is only the preferred mode of the present invention. The server cluster may implement multiple independent services that are all cooperatively load-balanced based on the type of network request initially received by a PEM component.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A method of managing the secure mutual configuration of a plurality of servers interconnected by a communications network, said method comprising the steps of:
a) routinely exchanging status messages between said plurality of servers wherein said status messages identify changes in the mutual configuration of said plurality of servers, wherein each said status message includes encrypted validation data and wherein said plurality of servers stores respective configuration data including respective sets of data identifying the servers known to the respective servers as constituting said plurality of servers;
b) validating status messages as respectively received by said plurality of servers against the respective configuration data stored by said plurality of servers wherein status messages are determined valid when originating from a first server as determined known relative to the respective configuration data of a second server; and
c) selectively modifying the respective configuration data of said second server.

2. The method of claim 1 wherein said step of selectively modifying includes the steps of:
a) retrieving the respective configuration data of said first server; and
b) incorporating the respective configuration data of said first server as the respective configuration data of said second server.

3. The method of claim 2 wherein the respective configuration data of said first server includes encrypted validation data and wherein said step of retrieving includes the step of validating the respective configuration data of said first server as originating from a known server of said plurality of servers as determined relative to the respective configuration data of a second server.

4. The method of claim 3 wherein said known server is said first server.

5. The method of claim 4 wherein the encrypted validation data included in the respective configuration data is a digital signature of the respective configuration data.

6. The method of claim 5 wherein the encrypted validation data included in the status messages includes an encrypted identifier of the respective servers originating the status messages.

7. The method of claim 6 the method of claim 6 wherein the respective configuration data includes respective sets of the public keys corresponding to the servers known to the respective servers as constituting said plurality of servers.

8. The method of claim 7 wherein the status messages include respective configuration data version identifiers and wherein said step of retrieving is responsive to configuration data version identifiers that are more current the configuration data version identifier of the respective configuration data held by a respective server of said plurality of servers.

9. The method of claim 8 wherein a predetermined server of said plurality of servers includes an administrative interface through which the respective configuration data may be modified, said method further comprising the step of revising the respective configuration data version identifier of administratively modified configuration data.

10. A method of securely distributing configuration data over a communications network to a plurality of computer systems, each computer system operating to evaluate configuration data, as stored in respective configuration data stores, in response to service requests to determine respective responses, said method comprising:
a) receiving, by a computer system, a version message from said communications network;
b) verifying said version message using verification encryption data securely held by said computer system;
c) determining, based on said version message, to retrieve updated configuration data from a configuration data source server identified relative to said a version number message; and
d) installing updated configuration data to the configuration data store of said computer system as retrieved from said configuration data source server, wherein said updated configuration data is retrieved as an encrypted data block and wherein said step of installing includes locating predetermined configuration data within said encrypted data block and decrypting said predetermined configuration data.

11. The method of claim 10 wherein said locating step determines the location of said predetermined configuration data using location encryption data securely held by said computer system.

12. The method of claim 11 wherein said verification encryption data and said location encryption data are related to a private encryption key securely held by said computer system.

13. The method of claim 12 wherein said verification encryption data and said location encryption data are related to respective private encryption keys securely held by said computer system.

14. The method of claim 10 wherein said plurality of computer systems use a common version of said configuration data, wherein said step of installing finally installs said updated configuration data for use by said computer system and wherein said method further comprises the steps of:
a) staging said updated configuration data pending completion of the installation of said updated configuration data; and
b) waiting for said plurality of computer systems to signal use of a common version of said configuration data whereupon said step of installing completes the installation of said updated configuration data.

15. The method of claim 14 wherein said computer system receives version message from each of the other ones of said plurality of computer systems, wherein said step of determining determines the latest version of configuration data in use or staged for use by each of the other ones of said plurality of computer systems, and wherein said step of waiting waits for each of the other ones of said plurality of computer systems to signal use of a common latest version of said configuration data.

16. The method of claim 15 wherein said plurality of computer systems to signal use of a common latest version of said configuration data through respective version messages.

17. A method of securely distributing configuration information through a communications network among a cluster of computer systems providing a network service, wherein configuration information modifications are distributed from a computer system participating in the cluster and mutually coordinated in installation in the participating cluster computer systems to enable a consistent configuration information versioned operation of said cluster of computer systems, said method comprising:
a) receiving a modified configuration data set having a predetermined configuration version;
b) preparing an encrypted configuration data set by encrypting said modified configuration data set using predetermined encryption keys corresponding to encryption key data included in said modified configuration data set;
c) sending a configuration version message, referencing said predetermined configuration version, over the communications network connecting the cluster of computer systems;
d) servicing requests to retrieve a copy of said encrypted configuration data set; and
e) coordinating, among the cluster of computer systems, installation of said modified configuration data set as the operative configuration data set of the computer systems of the cluster.

18. The method of claim 17 wherein the computer systems of said cluster respectively execute a common network service application, wherein execution of said common network service application is dependent on a respective installed configuration data set, and wherein said step of coordinating provides for the mutually corresponding installation of said modified configuration data set by said computer systems whereby execution of said common network service application is consistent across the cluster of computer systems.

19. The method of claim 18 wherein said modified configuration data set includes individual configuration data sets identified with respective computer systems of the cluster, wherein said modified configuration data set includes a plurality of private encryption keys and wherein said step of preparing provides for the encryption of said modified configuration data using said plurality of private encryption keys.

20. The method of claim 19 wherein said individual data sets are encrypted relative to respective ones of said plurality of private encryption keys and wherein a predetermined computer system of said cluster must hove a respective one of said plurality of private encryption keys to decrypt a corresponding one of said individual data sets from said encrypted configuration data set.

21. A method of securely distributing configuration data sets among server computer systems of a server cluster, wherein an operative configuration data set is used by an individual server computer system to define the parameters for executing a network service by that server computer system, said method comprising the steps of:
a) identifying, by a first server computer system of said server cluster, a revised configuration data set held by a second server computer system of said server cluster;
b) retrieving, by said first server computer system, said revised configuration data set from said second server computer system;
c) decrypting said revised configuration data set for installation as a current configuration data set for said first server computer system, said revised configuration data set having been uniquely encrypted for decryption by said first server computer system;
d) verifying, by said first server computer system, that each server computer system of said server cluster has said current configuration data set; and
e) installing said current configuration data set on said first server computer system as the operative configuration data for said first server computer system.

22. The method of claim 21 wherein said revised configuration data set includes a plurality of respectively encrypted current configuration data sets and wherein said step of decrypting includes the steps of:
a) locating said current configuration data set, as encrypted uniquely for said first server computer system, from among said plurality of respectively encrypted configuration data sets; and
b) discretely decrypting said current configuration data set from said revised configuration data set.

23. The method of claim 22 wherein said first server computer system has a unique private decryption key and wherein said step of locating depends on the identification, by said first server computer system, of a representation of said unique private decryption key in said revised configuration data set, whereby location and decryption of said plurality of respectively encrypted current configuration data sets is locked to the respective server computer systems of said server cluster.

24. The method of claim 23 wherein said revised configuration data set includes representations of the unique private decryption keys of the respective server computer systems of said server cluster and wherein said step of locating includes:
a) matching a predetermined representation of said unique private decryption key of said first server computer system with a corresponding one of said representations of said revised configuration data set; and
b) determining, based on the matched representation of said unique private decryption key of said first server computer system, the location of said current configuration data set, as encrypted, from among said plurality of respectively encrypted configuration data sets.

25. The method of claim 24 wherein said representations of the unique private decryption keys are secure digests of the unique private decryption keys of the respective server computer systems of said server cluster.

26. The method of claim 21 wherein said operative configuration data set includes a first version identifier and wherein said step of identifying includes:
a) receiving, by said first server computer system, version messages from the other server computer systems of said server cluster, wherein each version message includes a second version identifier and identifies a version message source server computer system; and
b) determining, with respect to a predetermined version message, whether said second version identifier, relative to said first version identifier, corresponds to said revised configuration data set.

27. The method of claim 26 wherein said step of identifying further includes a step of validating said version messages with respect to said first server computer system.

28. The method of claim 27 wherein said first server computer system has a unique private decryption key and wherein said step of validating depends on the identification, by said first server computer system, of a representation of said unique private decryption key in said version messages such that version messages lacking said representation are discarded by said first computer server computer system.

29. The method of claim 28 wherein said version message includes representations of the unique private decryption keys of the respective server computer systems of said server cluster and wherein said step of validating includes matching said representation of said unique private decryption key of said first server computer system with a corresponding one of said representations of said revised configuration data set.

30. The method of claim 29 wherein said representations of the unique private decryption keys are secure digests of the unique private decryption keys of the respective server computer systems of said server cluster.

31. The method of claim 30 wherein said revised configuration data set includes said representations of the unique private decryption keys and a plurality of respectively encrypted current configuration data sets, wherein said step of decrypting includes the steps of:
a) matching, by said first server computer system, of said predetermined representation of said unique private decryption key of said first server computer system in said revised configuration data set;
b) determining, based on the matched representation of said unique private decryption key of said first server computer system, the location of said current configuration data set, as encrypted, from among said plurality of respectively encrypted configuration data sets; and
c) discretely decrypting said current configuration data set from said revised configuration data set, whereby the location and decryption of said plurality of respectively encrypted current configuration data sets is locked to the respective server computer systems of said server cluster.

32. A server computer system coupleable through a communications network as part of a computer system cluster to support performance of a network service on behalf of a client computer system, said server computer system comprising:
a) a processor operative to execute control programs; and
b) a service program operative, through execution by said processor as a control program,
to generate responses to predetermined client requests,
wherein responses are generated based on an evaluation of an installed configuration data set,
said service program being further operative to implement a secure network protocol, interactive with said computer system cluster, to identify and receive an updated configuration data set for installation as said installed configuration data set,
said service program including a unique private encryption key,
wherein said secure network protocol provides for the transfer of an encrypted configuration data block including a plurality of encrypted updated configuration data sets, a respective one of said plurality of encrypted updated data sets being decryptable using said unique private encryption key.

33. The server computer system of claim 32 wherein said service program is operative to first locate and second decrypt said respective one of said plurality of encrypted updated data sets based on said unique private encryption key.

34. The server computer system of claim 33 wherein said encrypted configuration data block includes a plurality of location references, wherein said service program is operative to associate said unique private encryption key with a corresponding one of said plurality of location references, said service program being further operative to locate said respective one of said plurality of encrypted updated data sets based on said corresponding one of said plurality of location references.

35. The server computer system of claim 34 wherein said corresponding one of said plurality of location references is a secure digest of said unique private encryption key.

36. The server computer system of claim 34 wherein said service program is operative to determine whether to receive said updated configuration data set.

37. The server computer system of claim 36 wherein said installed configuration data set has a first version identifier, wherein said updated configuration data set has a second version identifier, said service program being responsive to said first and second version identifiers to determine whether to receive said updated configuration data set.

38. The server computer system of claim 37 wherein said service program is operative, in response to administrative modifications that produce said updated configuration data set, to generate said encrypted configuration data block with said second version identifier, said service program being further operative to provide a version message containing said second version identifier to said computer system cluster and responsive to requests to transfer said encrypted configuration data block.

39. The server computer system of claim 37 wherein said service program is operative to successively broadcast said version message.

40. The server computer system of claim 39 further comprising a first network connection coupleable to said client computer system and a second network connection coupleable to said computer system cluster, wherein said second network connection is utilized to successively transfer said version message and to transfer said encrypted configuration data block.

41. The server computer system of claim 40 further comprising a third network connection accessible by an administrator for applying administrative modifications that produce said updated configuration data set.

42. A method of securely constraining participation of select computer systems in the cooperative operation of a server cluster to insure the integrity of the information transactions among the computer systems of said server cluster, said method comprising the steps of:
a) receiving, by a first computer system of a server cluster, a request for the transfer of first specified data, held in a first secure memory store of said first computer system, to a second computer system of said server cluster;
b) transmitting, by said first computer system, encrypted information including said first specified data to said second computer system, wherein said encrypted information, as prepared by said first computer system, is further encoded to include a first secure discrete reference;
c) verifying said first secure discrete reference against a second secure discrete reference determinable from second specified data stored in a second secure memory store of said second computer system;
d) locating, by said second computer system with respect to said first secure discrete reference, a predetermined subset of said encrypted information decryptable by said second computer system to recover said first specified data; and
e) installing said first specified data in said second secure memory store of said second computer system.

43. The method of claim 42 wherein said request and said encrypted information are transferred over a communication network interconnecting the computer systems of said server cluster.

44. The method of claim 43 wherein said first and second secure discrete references are secure digests of a secure private encryption key assigned to said second computer systems.

45. The method of claim 44 wherein said first and second specified data respectively includes said first and second secure discrete references.

46. The method of claim 44 wherein said first and second specified data includes said secure private encryption key.

47. The method of claim 44 wherein each of the computer systems of said server cluster are assigned unique secure private encryption keys and wherein a set of secure discrete references, including said first and second secure discrete references, corresponding to the set of unique secure private encryption keys are determinable from the respective specified data stored by said computer systems of said server cluster.

48. The method of claim 47 wherein the set of unique secure private encryption keys are stored in each of the respective specified data stored by said computer systems of said server cluster.

49. The method of claim 47 wherein the respective specified data stored by said computer systems of said server cluster are versioned, said method further comprising the steps of:
a) identifying, by said second computer system, that said first specified data is a later version relative to the version of said second specified data; and
b) requesting, by said second computer system, said first specified data from said first computer system.

50. The method of claim 49 further comprising the step of coordinating, relative to others of said computer systems of said server cluster, the installation of said first specified data by said second computer system.

51. The method of claim 50 wherein said step of identifying further identifies said first specified data as the latest available version of the respective specified data.

52. The method of claim 50 wherein said second computer system nominally responds to predetermined client requests, said method further comprising the step of declining, by said second computer system, said predetermined client requests in the interim between said step of identifying and said step of installing.

53. A method of distributing configuration control data among a cluster of computer systems to ensure consistent operation of the cluster in response to network requests received from host computers, wherein each computer system maintains a local control data set that, in active use, determines the functional operation of the respective computer system, and wherein said cluster of computer systems and said host computers are interconnected by a communications network, said method comprising the steps of:
a) storing, in a first computer system of a cluster of computer systems, a first local control data set having a predetermined version number;
b) transmitting a cluster message including said predetermined version number from said first computer system to said cluster of computer systems;
c) transferring said first local control data set to requesting computer systems of said cluster of computer systems; and
d) synchronizing with said requesting computer systems the installation of said first local control data set for active use by said requesting computer systems.

54. The method of claim 53 further comprising the step of changing said predetermined version number in connection with a predetermined modification of said first local control data set, wherein said requesting computer systems are responsive to the change in said predetermined version number.

55. The method of claim 54 wherein said step of synchronization includes the steps of:
a) providing, respectively by said requesting computer systems, readiness signals to said cluster to establish a readiness to install said first local control data set; and
b) establishing, respectively by said requesting computer systems, receipt of said readiness signals from all of said requesting computer systems to enable respective installation of said first local control data set for active use.

56. The method of claim 55 wherein each actively participating computer system of said cluster routinely performs said step of transmitting, wherein each actively participating computer system may be a requesting computer system relative to any other participating computer system that transmits a cluster message with a relatively more recently predetermined version number, wherein said readiness signals include respective predetermined version numbers, and wherein said step of establishing converges on a common predetermined version number.

57. The method of claim 56 wherein said cluster messages securely circumscribe said actively participating computer systems relative to said respectively transmitting computer systems.

58. The method of claim 57 wherein said readiness signals include respective cluster messages.

59. A method of enabling the secure, consistent, single-point management of the individual computer system configurations within a cluster of computer systems provided to perform a common network service in response to network requests provided by host computers, wherein said cluster of computer systems and said host computers are interconnected by a communications network, said method comprising the steps of:
a) providing each of said computer systems of said cluster with a active configuration data set that operatively defines the respective operation of said computer system with respect to network requests received from host computers, wherein said active configuration data sets are represented by predefined version values;
b) transmitting, mutually among said computer systems of said cluster, cluster messages including respective representations of said predefined version values;
c) supporting, with respect to a predetermined computer system of said cluster, provision of a updated configuration data set for installation as said active configuration data set, said updated configuration data set having an updated version value, and wherein said cluster messages transmitted by said predetermined computer system reflect said updated version value;
d) propagating said updated configuration data set from said predetermined computer system among said computer systems of said cluster; and
e) coordinating the installation of said updated configuration data set as said active configuration data set in each of said computer systems of said cluster.

60. The method of claim 59 wherein said step of coordinating provides for the installation of said updated configuration data set determined respectively based on a convergence of the version values received in said cluster messages from the computer systems of said cluster.

61. The method of claim 60 wherein said provision of said updated configuration data set includes administrative provision.

62. The method of claim 61 wherein said provision of said updated configuration data set includes a modification of the local active configuration data set.

63. The method of claim 62 wherein said step of coordinating provides for the respective installation of said updated configuration data set by the computer systems of the cluster once a respective computer system receives a predetermined number of said cluster messages from each of the other computer systems of said cluster each including said updated version value.

64. The method of claim 63 wherein said predetermined number is two.

65. A method of securely establishing consistent operation of a networked cluster of computer systems to provide a network service on behalf of host computer systems, said method comprising the steps of:
a) enabling distribution of an updated configuration data set among a cluster of computer systems, wherein each said computer system is operative against a respective active configuration data set, and wherein respective instances of said updated configuration data set are received and held by said cluster of computer systems pending installation as said respective active configuration data sets;
b) determining, by each said computer system, when a predetermined installation criteria is met with respect to each said computer system; and
c) installing said respective instances of said updated configuration data set as said respective active configuration data sets.

66. The method of claim 66 wherein said step of enabling distribution includes a step of transmitting a message to said cluster of computer systems and wherein said message is encrypted so as to be readable only by those computer systems of said cluster that are predetermined valid participants in said cluster.

67. The method of claim 67 wherein said message, as prepared by a first computer systems of said cluster, is encrypted so as to be readable only by second computer systems of said cluster that are preestablished to said first computer system as valid participants of said cluster.

68. The method of claim 68 further comprising the step of preparing, by said first computer system, said message utilizing encryption codes respectively corresponding to said second computer systems.

69. The method of claim 69 wherein said first computer system securely stores a preestablished set of public key encryption codes corresponding to said second computer systems and wherein said second computer systems are only responsive to said message where said message stores a secure representation of the respective public key encryption code of a corresponding one of said second computer systems that receives said message.

70. The method of claim 65 further comprising the steps of:
a) storing, by a first computer system of said cluster, a set of encryption codes corresponding to second computer systems of said cluster, said set of encryption codes being preestablished, representing predetermined valid participants in said cluster, and securely stored by said first computer system;
b) preparing, by said first computer system, a message for distribution to said second computer systems, said message including secure representations of said encryption codes;
c) transmitting said message to said cluster; and
d) validating said message by said second computer systems upon recognizing respective instances of said representations of said encryption codes.

71. The method of claim 70 further comprising the step of retrieving, by a predetermined second computer system, a copy of said set of encryption codes from said first computer system for use by said predetermined second computer system subsequently in the role of said first computer system.

72. The method of claim 71 wherein said secure representations are secure hashes of the public keys of said second computer systems.

73. A method of securely constraining participation of select computer systems in the operation of a server cluster, interconnected by a communications network, to insure the security of configuration information distributed among the computer systems of said server cluster, said method comprising the steps of:
a) storing, by a first computer system of a server cluster, first specified data within a secure memory store, said first specified data being identified by a first version identifier;
b) receiving, by said first computer system, a cluster message including a second version identifier and verification data from a second computer system of said server cluster;
c) verifying, by said first computer system, said cluster message by evaluation of said verification data relative to said first specified data;
d) obtaining, from said second computer system, dependent on a successful verification of said verification data, encrypted information including second specified data corresponding to said second version identifier;
e) decrypting said second specified data from said encrypted information; and
f) incorporating said second specified data into said secure memory store of said first computer system, whereby the operation configuration of said first computer system is securely made consistent with that of said second computer system.

74. The method of claim 73 wherein said first and second specified data is configuration information that, as incorporated in said secure memory store, determines the operational performance of said first computer system of said server cluster in responding to network requests issued by any of a plurality of host computer systems to obtain a performance of a network service.

75. The method of claim 74 wherein said first specified data includes a predetermined set of encryption codes corresponding to the validly participating computer systems of said server cluster as known to said first computer system, and wherein said step of validating said cluster message includes requiring the valid decryption of said verification data using an encryption code of said predetermined set identified with said second computer system, whereby cluster messages are accepted as valid by said first computer system only from preestablished validly participating computer system of said server cluster.

76. The method of claim 75 wherein changes to said predetermined set of encryption codes are constrained to secure update procedures including incorporation of said second specified data into said secure memory store and administrative operations securely executed against a computer system of said server cluster, whereby configuration data is securely maintained and distributed only among the computer systems of said server cluster of administratively preestablished identity.

77. The method of claim 76 wherein said verification data includes a predetermined cipher text encrypted to ensure secure identification of said request as originating from said second computer system.

78. The method of claim 77 wherein said verification data includes a predetermined cipher text encrypted with an encryption key pair corresponding to said second computer system.

79. A computer system operable as a participant in a cluster of computer systems providing a network service in response to network requests received from host computer systems through a communications network, the cluster computer systems interoperating to ensure the security and secure exchange of configuration data in response to a single point secure administrative modification of configuration data on any computer system of the cluster, said computer system comprising:
a) a computer memory providing for the storage of configuration data including a set of identifications of computer systems participating in a preestablished computer system cluster;
b) a processor coupled to said computer memory and operative to execute a control program that defines performance of a predetermined network service in response to network requests as received from host computers, wherein performance of said predetermined network service is controlled by said configuration data;
c) an administrative interface coupled to said processor, wherein said control program further enables secure performance of local administrative modifications to said configuration data through said administrative interface; and
d) a communications interface coupled to said processor and coupleable to said preestablished computer system cluster, wherein said control program further enables secure synchronization of said configuration data among said computer system and said preestablished computer system cluster, said control program limiting the transfer of said configuration data between said computer system, as a first computer system, and a second computer system securely matching a identification preexisting in said set of identifications.

80. The computer system of claim 79 wherein said configuration data is transferred encrypted between said first computer system and said second computer system and wherein the encryption of said configuration data is specific to said first computer system and said second computer system.

81. The computer system of claim 80 wherein said processor is responsive to a network synchronization message identifying a configuration data set more recently modified relative to the configuration data stored in said computer memory, said processor being operative to identify said second computer system as the source of said network synchronization message, send a network configuration data request message to said second computer system. receive, and decrypt said configuration data set, and incorporate said configuration data set into said computer memory.

82. The computer system of claim 81 wherein said processor is further operative to validate said network synchronization message relative to said set of identifications, prepare said network configuration data request to be validateable against said set of identifications, and validate said configuration data set as received against said set of identifications, whereby the transfer of said configuration data set is secure and constrained with respect to said first computer system to those computer systems of said preestablished computer system cluster that are preexistingly identified by said set of identifications.
